(19) United States
(12) Patent Application Publication
(10) Pub. No.: US 2026/0127642 A1
(43) Pub. Date: May 7, 2026

(54) Sports Team Review Device

(71) Applicant: Forrest Smith, Mountain House, CA (US)

(72) Inventor: Forrest Smith, Mountain House, CA (US)

(21) Appl. No.: 19/201,513

(22) Filed: May 7, 2025

Related U.S. Application Data
(60) Provisional application No. 63/716,977, filed on Nov. 6, 2024.

(51) Int. Cl. G06Q 30/0282; G06F 3/0481

(52) U.S. Cl. CPC G06Q 30/0282; G06F 3/0481

(57) ABSTRACT

A sports team review device is provided. The device is comprised of a mobile application or computer software platform for reviewing youth travel sports teams, designed to assist families and individuals in evaluating teams before committing to tryouts or enrollment. The platform includes a browsing option with advanced filtering tools that allow users to search by sport type, region, age group, and other factors like cost, coaching standards, and facilities. Users can create personal profiles with options for anonymity or verified membership, promoting privacy and platform trust. The review feature allows detailed feedback, categorizing aspects such as coaching quality, team culture, and safety, and supports media uploads for enhanced authenticity. A “red flag” indicator highlights teams with poor ratings, while discussion boards and a Q&A section facilitate community interaction on topics like travel advice and team recommendations, creating a collaborative space for information sharing.

### CROSS-REFERENCE TO RELATED APPLICATION

The present application claims priority to, and the benefit of, U.S. Provisional Application No. 63/716,977, which was filed on Nov. 6, 2024, and is incorporated herein by reference in its entirety.

### FIELD OF THE INVENTION

The present invention relates generally to the field of mobile applications. More specifically, the present invention relates to a platform for families to review and assess youth travel sports teams using detailed criteria, advanced filters, and a structured review system with options for anonymity and verification. The platform also features discussion boards, a Q&A section, and a “red flag” indicator to facilitate informed decision-making and community interaction on topics relevant to youth sports travel. Accordingly, the present disclosure makes specific reference thereto. Nonetheless, it is to be appreciated that aspects of the present invention are also equally applicable to other like applications, devices, and methods of manufacture.

### BACKGROUND

Youth travel sports have become a significant part of many children's athletic development, providing structured opportunities for competition, skill enhancement, and teamwork beyond local leagues. However, as these programs often require a considerable investment of time, money, and commitment, parents are increasingly concerned about the quality and standards of various teams and organizations. Many families go into these programs with limited information, relying on team websites or word-of-mouth references that may not provide a complete or balanced view of the experience. Additionally, the pressures associated with youth travel sports—long travel distances, high costs, and intense competition—amplify the stakes for both children and parents when choosing a program. Unfortunately, poor experiences in travel sports can have negative emotional and developmental impacts on children, potentially discouraging them from participating in sports altogether.

Furthermore, parents often lack any centralized platform to voice their concerns or share honest feedback about youth travel teams. Traditional online review platforms generally do not cater to this niche, and team-specific information shared on social media is often scattered, difficult to verify, and may not guarantee anonymity. This gap leaves parents without a reliable way to identify and connect with others who have had experiences with these organizations. Without a way to hold teams accountable, some coaches or organizations may continue operating with questionable practices, which could include inconsistent coaching, unfair treatment, or misaligned priorities that fail to prioritize children's development and well-being. Consequently, there is a strong need for a dedicated platform where parents can find detailed, firsthand accounts of others'experiences and share their own. Such a resource would allow families to make better-informed decisions, ultimately improving the quality of youth travel sports experiences across the board.

Therefore, there exists a long-felt need in the art for a sports team review device that allows parents to anonymously share feedback on youth travel sports teams to support informed decision-making. There also exists a long-felt need in the art for a sports team review device that enables parents to warn other families about potentially substandard programs, helping them avoid poor experiences. Moreover, there exists a long-felt need in the art for a sports team review device that holds sports teams and coaches accountable by providing a transparent review platform focused on user-submitted experiences.

The subject matter disclosed and claimed herein, in one embodiment thereof, comprises a sports team review device. The device is comprised of a mobile application or computer software platform for reviewing youth travel sports teams, designed to assist families and individuals in evaluating teams before committing to tryouts or enrollment. The platform includes a browsing option with advanced filtering tools that allow users to search by sport type, region, age group, and other factors like cost, coaching standards, and facilities. Users can create personal profiles with options for anonymity or verified membership, promoting privacy and platform trust. The review feature allows detailed feedback, categorizing aspects such as coaching quality, team culture, and safety, and supports media uploads for enhanced authenticity. A “red flag” indicator highlights teams with poor ratings, while discussion boards and a Q&A section facilitate community interaction on topics like travel advice and team recommendations, creating a collaborative space for information sharing.

In this manner, the sports team review device of the present invention accomplishes all the forgoing objectives and provides a comprehensive mobile application and website designed to facilitate the anonymous review of youth travel sports teams. Through this platform, parents can create profiles, upload multimedia content, and leave reviews that contribute to a detailed database of user experiences across a variety of sports programs. These features enable families to make better-informed decisions by choosing teams with proven positive environments, avoiding those with poor reputations, and selecting programs that meet their unique expectations. By fostering transparency and enabling accountability, the sports team review device encourages higher standards within youth sports organizations, helping to create a supportive and positive environment for young athletes and their families.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a sports team review device. The device is comprised of a mobile application and/or computer software that serves as a platform for reviewing youth travel sports teams, allowing families and individuals to access and share team reviews to aid in evaluation before tryouts or enrollment.

The device includes a browsing option that enables users to filter content by criteria such as sport type, region, age group, and team rating, facilitating the discovery of relevant teams and reviews. Integrated advanced filtering tools allow users to customize search results by factors like team quality, costs, coaching standards, and facilities, enhancing decision-making with tailored results.

A personal profile feature allows users to interact on the platform anonymously or as verified members, enabling secure sharing of reviews and engagement in discussions. An optional verification process enhances platform reliability by confirming identities privately, thereby reducing spam and abusive content.

The review feature allows users to rate teams and provide feedback on coaching, culture, expenses, facilities, and other team attributes, supporting structured, targeted reviews. Media upload options enable photo and video attachments, while a relationship verification option enhances credibility. A timeline feature allows reviewers to indicate their length of engagement with teams.

The review feature also incorporates a “red flag” indicator, which alerts users if a team consistently receives poor ratings, helping families avoid potential issues.

The device further includes a discussion board for families to discuss travel-related topics, share advice, and recommend teams. A Q&A section within the discussion board allows users to ask questions on team-specific or general topics, fostering interactive dialogue and enhancing the platform's resources.

Accordingly, the sports team review device of the present invention is particularly advantageous as it provides a comprehensive mobile application and website designed to facilitate the anonymous review of youth travel sports teams. Through this platform, parents can create profiles, upload multimedia content, and leave reviews that contribute to a detailed database of user experiences across a variety of sports programs. These features enable families to make better-informed decisions by choosing teams with proven positive environments, avoiding those with poor reputations, and selecting programs that meet their unique expectations. By fostering transparency and enabling accountability, the sports team review device encourages higher standards within youth sports organizations, helping to create a supportive and positive environment for young athletes and their families.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a sports team review device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a sports team review device that allows parents to anonymously share feedback on youth travel sports teams to support informed decision-making. There also exists a long-felt need in the art for a sports team review device that enables parents to warn other families about potentially substandard programs, helping them avoid poor experiences. Moreover, there exists a long-felt need in the art for a sports team review device that holds sports teams and coaches accountable by providing a transparent review platform focused on user-submitted experiences.

The present invention, in one exemplary embodiment, is comprised of a sports team review device. The device comprises a mobile application and/or computer software that provides a platform for reviewing youth travel sports teams, allowing families and individuals to access and share team reviews for evaluation before tryouts or enrollment.

The device includes a browsing option that lets users filter content by criteria such as sport type, region, age group, and team rating, simplifying the search for relevant teams and reviews. Advanced filtering tools allow customization of search results based on factors like team quality, costs, coaching standards, and facilities, supporting well-informed decisions.

A personal profile feature enables users to interact on the platform either anonymously or as verified members, allowing secure sharing of reviews and participation in discussions. An optional verification process enhances reliability by confirming identities privately, reducing spam and abusive content.

The review feature enables users to rate teams and provide structured feedback on aspects like coaching, culture, expenses, and facilities. Media upload options allow photo and video attachments, and a relationship verification feature enhances credibility. A timeline feature enables reviewers to indicate the duration of their engagement with teams.

The review feature also includes a “red flag” indicator to alert users if a team consistently receives poor ratings, aiding families in avoiding potential issues.

The device further provides a discussion board for families to discuss travel-related topics, share advice, and recommend teams. A Q&A section within the discussion board allows users to ask questions about specific teams or general topics, encouraging interaction and enriching the platform's resources.

Accordingly, this sports team review device offers a comprehensive mobile and web-based platform for anonymous review of youth travel sports teams. Through features like profile creation, multimedia uploads, and detailed reviews, families can make informed choices by selecting teams with strong reputations, avoiding those with negative feedback, and choosing programs that meet their expectations. This device promotes transparency, accountability, and higher standards within youth sports organizations, fostering a supportive environment for young athletes and their families.

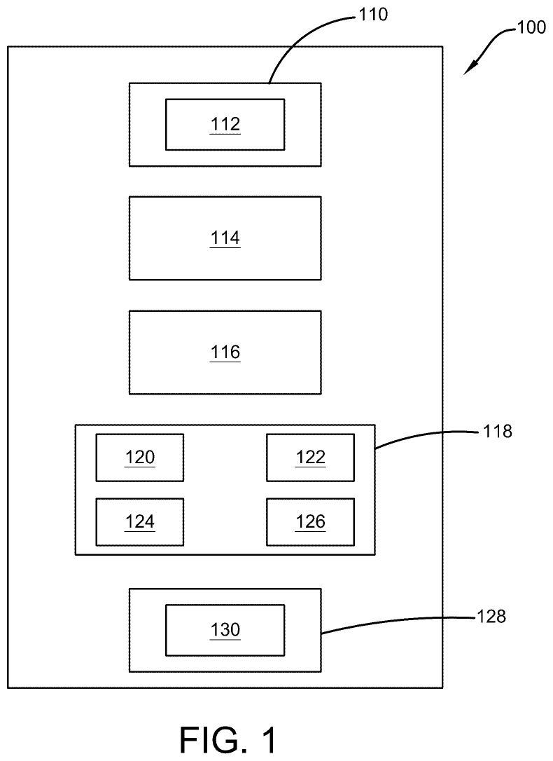

Referring initially to the drawings, FIG. 1 illustrates a perspective view of one potential embodiment of a sports team review device 100 of the present invention in accordance with the disclosed architecture. The device 100 is comprised of a mobile application and/or computer software that provides a platform for reviewing travel youth sports teams. This platform allows families and individuals to share and access reviews focused specifically on travel sports teams for young athletes, helping users evaluate teams before committing to tryouts or enrollment.

The device 100 is comprised of a browsing option 110 that allows a user to filter content by various criteria, including sport type, geographic region, age group, and team rating, making it easier to locate the most relevant teams and reviews. Additionally, the browsing option 110 is integrated with advanced filtering tools 112, which support further customization of search results based on specific factors such as team quality, cost structure, coaching standards, and available facilities. These advanced filters 112 enhance the user experience by providing a tailored view of team options that align with the user's desired criteria, supporting well-informed decision-making.

The device 100 provides users with the capability to create a personal profile 114 within the application. This profile 114 enables the user to interact on the platform both anonymously and as a verified member, providing a versatile approach to privacy. For public-facing actions, such as submitting team reviews or participating in discussion boards, users have the option to remain anonymous, promoting a sense of security and privacy and thereby reducing reluctance to share personal insights. Alternatively, a verification feature 116 is available, allowing users to privately authenticate their profiles with app administrators. This verification process 116 allows users to confirm their identities without publicly displaying personal identifiers. By incorporating this optional verification feature, the device 100 enhances trust and platform reliability by deterring spam accounts and limiting abusive content.

The device 100 includes a review feature 118 that enables users to provide feedback on various traveling sports teams. The review feature 118 may comprise voting buttons, allowing users to rate feedback as either “Helpful” or “Not Helpful”. The review feature 118 supports a plurality of review categories 120, encompassing aspects such as coaching quality, team culture, travel expenses, facilities, skill development, communication quality, and player safety. This categorization provides a structured review format, making it easier for users to find targeted information on specific areas of interest. Users may enhance their reviews with media upload options 122, enabling them to attach photos and videos for a more comprehensive and authentic presentation. Additionally, the review feature 118 includes an option for users to verify their relationship 124 to the team being reviewed, such as through anonymous confirmation with team representatives. Verified reviews lend credibility to feedback, enabling other users to trust the authenticity of shared experiences. To offer contextual insight, reviewers may also include a timeline summarizing their interaction with the team, providing readers with an understanding of the duration and depth of their engagement.

The review feature 118 also integrates a “red flag” indicator 126, designed to alert users if a team consistently receives low ratings or significant negative feedback. This indicator 126 aids families by signaling potential issues, helping them make more informed decisions about team selection.

The device 100 further comprises at least one discussion board 128, which allows users, particularly families, to engage in discussions around topics like travel advice, cost-sharing strategies, team recommendations, and other relevant themes. This feature promotes a collaborative network of users with shared interests. Additionally, a Q&A section 130 is available within the discussion board 128, enabling users to pose questions and receive answers directly related to specific teams or general topics of interest, thus fostering interactive dialogue and enriching the platform's informational resources.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “sports team review device” and “device” are interchangeable and refer to the sports team review device 100 of the present invention.

Notwithstanding the forgoing, the sports team review device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the sports team review device 100 as shown in the FIGS. are for illustrative purposes only, and that many other sizes and shapes of the sports team review device 100 are well within the scope of the present disclosure. Although the dimensions of the sports team review device 100 are important design parameters for user convenience, the sports team review device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A sports team review device comprising:
a software platform configured to enable a user to share and access a review of a travel sports team;
a browsing option configured to allow the user to filter a team information by a sport type, a geographic region, an age group, and a team rating;
a profile feature allowing the user to create a profile with options for an anonymous interaction and a verified interaction;
a review feature configured to allow the user to provide a team feedback across a review category; and
a discussion board.

2. The sports team review device of claim 1 further comprised of a filter.

3. The sports team review device of claim 2, wherein the filter refines a search result based on a team quality, a cost structure, a coaching standard, or an available facility.

4. The sports team review device of claim 1 further comprised of a media upload option.

5. The sports team review device of claim 4, wherein the media upload option allows a user to attach a photo or a video to a review.

6. The sports team review device of claim 1, wherein the review feature is comprised of a voting button.

7. The sports team review device of claim 6, wherein the voting button is comprised of a “helpful” button.

8. The sports team review device of claim 6, wherein the voting button is comprised of a “not helpful” button.

9. The sports team review device of claim 1, wherein the review feature is comprised of a verification option that allows a user to confirm their relationship with a team being reviewed.

10. The sports team review device of claim 1, wherein the discussion board is comprised of a Q&A section.

11. A sports team review device comprising:
a software platform configured to provide a browsing option with a filtering tool;
a profile feature allowing a user to interact on the platform as an anonymous or a verified member;
a review feature comprising a voting button, a media upload option, and an option for a user to verify their relationship with a team being reviewed on the software platform;
a red flag indicator; and
a discussion board comprised of a Q&A section.

12. The sports team review device of claim 11, wherein the voting button is comprised of a “helpful” button.

13. The sports team review device of claim 11, wherein the voting button is comprised of a “not helpful” button.

14. The sports team review device of claim 11, wherein the filtering tool refines a search result based on a team quality, a cost structure, a coaching standard, or an available facility.

15. A sports team review device comprising:
a software platform configured to enable creation of a profile with a verification feature that allows a user to authenticate the profile without publicly displaying personal information;
a review feature that organizes feedback by a review category;
a media upload option within the review feature, allowing users to attach a photo or a video to a review;
a red flag indicator; and
a discussion board.

16. The sports team review device of claim 15, wherein the review category is comprised of a coaching quality, a team culture, a travel expenses, or a player safety.

17. The sports team review device of claim 15, wherein the red flag indicator is configured to alert users if a team consistently receives negative feedback.

18. The sports team review device of claim 15, wherein the discussion board is comprised of a Q&A section.

19. The sports team review device of claim 15, wherein the software platform is comprised of a mobile application.

20. The sports team review device of claim 15, wherein the software platform is comprised of a computer software.
